(19) United States
(12) Patent Application Publication
(10) Pub. No.: US 2022/0260331 A1
(43) Pub. Date: Aug. 18, 2022

(54) Loaded Chamber Warning Band

(71) Applicants: Robert H. Meier, Dekaly, IL (US); Leslie A. Wagner, Mukwonago, WI (US); Robert D. Rohr, Laotto, IN (US); Susan E. Arndt, Saint Paul, MN (US)

(72) Inventors: Robert H. Meier, Dekaly, IL (US); Leslie A. Wagner, Mukwonago, WI (US); Robert D. Rohr, Laotto, IN (US); Susan E. Arndt, Saint Paul, MN (US)

(21) Appl. No.: 17/178,246

(22) Filed: Feb. 18, 2021

(51) Int. Cl. F41A 17/20; F41A 35/02; G09F 3/04; G09F 23/00

(52) U.S. Cl. CPC F41A 17/20; F41A 35/02; G09F 2003/0208; G09F 23/00; G09F 3/04

(57) ABSTRACT

The invention is a flexible warning band device that fits a variety of firearm sizes and shapes and warns that a firearm may contain a live round

### CROSS-REFERENCE TO RELATED APPLICATIONS

This application claims the benefit of Provisional Patent Application Ser. No. 63/100,163, filed 2020 Mar. 2by the present inventors.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### SEQUENCE LISTING

Not applicable.

### STATEMENT REGARDING PRIOR DISCLOSURES BY THE JOINT INVENTORS

Not applicable

### BACKGROUND OF THE INVENTION

Inspiration for the invention came about from the inventors who own firearms and realized they wanted to identify arms that may have live ammunition in the firearm. With the use of a loaded chamber elastomeric warning band (the band), firearms can be readily identified from a distance as containing live rounds. The band can be readily installed or readily removed on firearms and provides a mean to indicate a loaded chamber on firearms where a loaded chamber indicator is not part of the design of the firearm.

### BRIEF SUMMARY OF THE INVENTION

The invention relates to the general field of firearm warning devices and would have specific application to individuals who may be in near proximity to firearms especially if the firearm may be loaded and ready for firing. The band, shown in FIG. 1 installed on a handgun, has a written message that raises awareness to the firearm handler that the firearm may be loaded and covers certain controls of the firearm thus reducing access.

The band serves as a buffer to environmental elements such as plant matter, dirt, mud or moisture from entering the firearm mechanisms that are typically used to load, lock, fire, extract and eject rounds.

The warning band is intended for use on firearms of various sizes (FIG. 1 Ref. 12 and FIG. 2 Ref. 13) and may be used by anyone who owns or is near firearms whether outdoors, in the home or workplace. There are different closure options, each covering a different range of difficulty and speed to install and remove. Examples of use are in settings where incidental or unintended contact may occur, use by law enforcement agencies who may have firearms loaded and in a state of readiness, or where firearms are displayed at shows, competitive shooting events, shooting clubs and ranges, or other uses including protection of the action from weather and environmental elements.

### BRIEF DESCRIPTION OF THE DRAWINGS

Various embodiments of the invention are disclosed in the following detailed description and accompanying drawings.

FIG. 1 illustrates a view of the warning band, Ref. 10 installed on a handgun Ref. 11.

FIG. 2 illustrates the warning band, Ref. 10 secured on a long gun firearm, Ref. 12.

FIG. 3 illustrates an isometric view of the flexible band, Ref. 10 showing the band closures Ref 13, warning text Ref. 14, printable area Ref.15, and the grip area Ref. 16.

FIG. 4 illustrates an isometric view of the flexible band, Ref. 10 in a open flat position, showing stretch directions Ref 17.

FIG. 5 illustrates an Isometric view of the band, Ref 10, showing a knob post, Ref 18 and band holes, Ref 19, closure option

FIG. 6 illustrates an isometric view of the band, Ref. 10 showing a buckle closure option with a slotted buckle piece (Ref 20) and a tab buckle piece (Ref. 21).

### DETAILED DESCRIPTION OF THE INVENTION

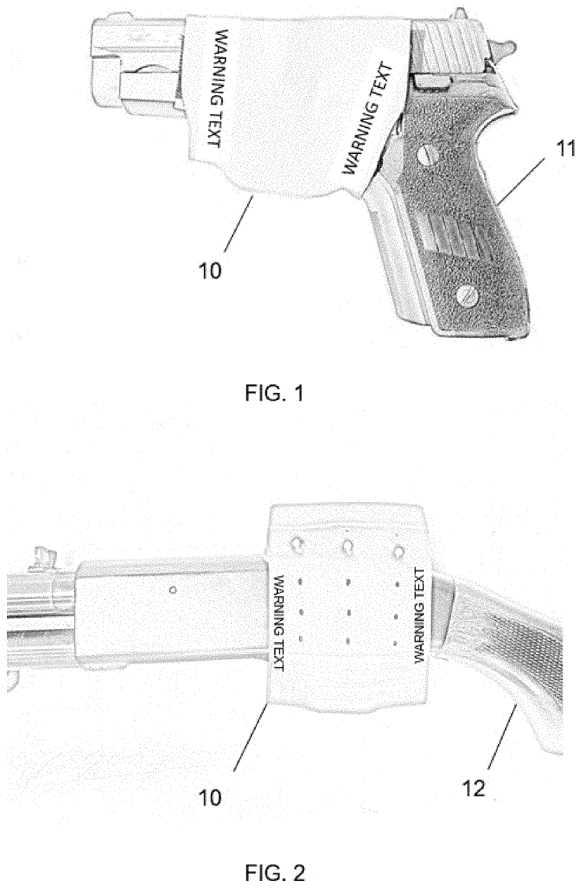

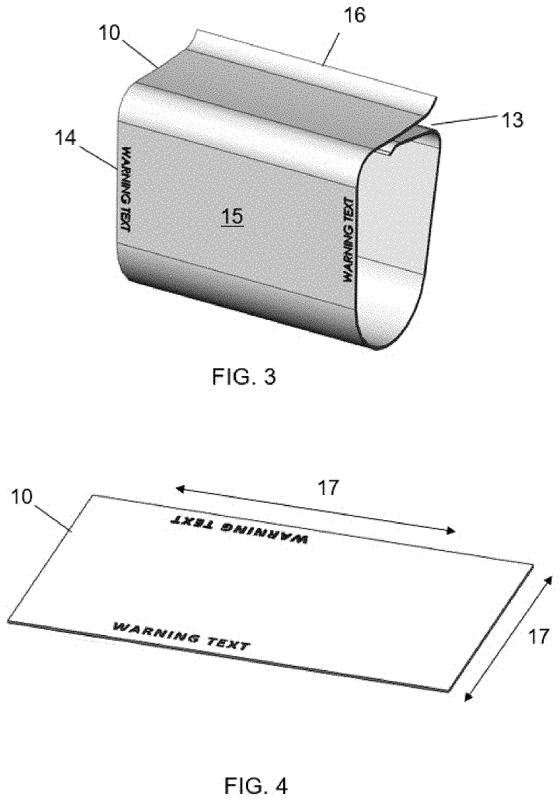

The invention is a flexible elastomeric warning band (FIG. 1 and FIG. 2) for firearms with the intended use of warning the holder that the firearm may be loaded with live ammunition and in a position ready to discharge. The band consisting of a polyhedroid piece, (FIG. 3 Ref. 10), a closure (FIG. 3 Ref. 13), a warning text (FIG. 3 Ref. 14), an area for promotional text (FIG. 3 Ref. 15), and a grip area (FIG. 3 Ref. 16) for installation and removal.

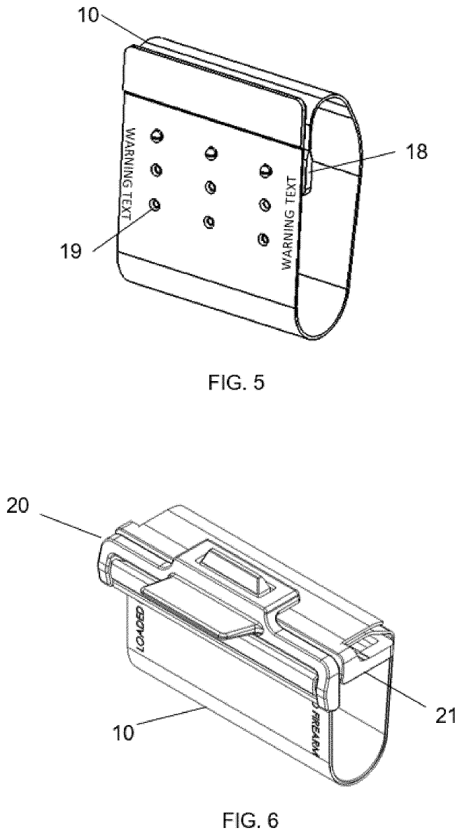

The polyhedroid band (FIG. 4 Ref. 10) is comprised of a synthetic or natural polymer flexible elastomeric material that has expansion and contracting properties allowing for stretch in any direction (FIG. 4 Ref. 17). The dimensions of the polyhedroid provide thickness sufficient to maintain flexibility while requiring an effort of strength to secure and unsecure the band ends. The dimensions are also of sufficient length to wrap around a firearm and have sufficient width to cover the firearm's action and controls which include but are not limited to the trigger region, the safety, magazine release, hammer, and slide/bolt release. In addition, the polyhedroid piece serves as a buffer to environmental elements such as plant matter, dirt, mud or moisture from entering the firearm openings to mechanisms that load, lock, fire, extract and eject rounds. The band flexibility allows it to fit and conform to the shape of a variety of firearms. The band may have resistive removal force to disengage the mating closure ends (FIG. 3, Ref 13, FIG. 5 Ref. 18 and Ref. 19, and FIG. 6, Ref. 20 and Ref. 21).

The band is made by using processes common in the manufacturing of plastics and rubber components. Such processes would include, but are not limited to, extrusion and molding. Text on the band is integrated into the band surface by a printed or molded process. The text includes a warning and may also include other informative messages.

The warning band is secured on the firearm by fastening the two length ends of the band together, thus closing the band to completely encircle the firearm trigger region and controls on various firearms. Several different closure designs and mechanisms are available, each providing for different speed and requiring different strength to attach and remove. The closure options can comprise of hook and loop material (FIG. 3), hole over post (FIG. 5), and buckles of various designs (FIG. 6). The closure mechanism can also be of a more complex design such as a mechanical lock.

The warning band is secured to the firearm by placing the end opposite the grip tab (FIG. Ref. 13) against the firearm top surface over the chamber area. Holding the opposite end of grip tab end firmly in place, using the grip tab (FIG. 3 Ref. 16) stretch the band down, one side of the firearm, across one side of the trigger region, under, then up the opposite side of the trigger region of the firearm gently stretching the band and engage the closure. To remove the band, the user firmly grips the tab (FIG. 3 Ref. 16), gently stretches and lifts upward releasing the closure.

1. A warning band device (FIG. 3) that consists of a flexible band (FIG. 3. Ref 10), a closure (FIG. 3, Ref 13), a displayed warning text (Fig. Ref. 14) promotion text area (FIG. 3 Ref. 15) and a grip area (FIG. 3 Ref 16) for installation and removal.

2. The warning band device in claim one is manufactured from a flexible material (FIG. 4, Ref. 17) capable to conform to a variety of firearm shapes.

3. The warning band device in claim one has properties of elongation and contraction (FIG. 4, Ref. 17) in any direction allowing it to configure to a multitude of sizes.

4. The warning band device in claim one may have resistive removal force.

5. The warning band device in claim 1 covers some mechanism openings to buffer ingress of contaminants.

6. The warning band device in claim one provides printable area for promotional information.
